(19) United States
(12) Patent Application Publication
(10) Pub. No.: US 2012/0007904 A1
(43) Pub. Date: Jan. 12, 2012

(54) PRINTING DEVICE

(75) Inventors: Sumito ANZAI, Shiojiri (JP); Eiichi MIYASHITA, Okaya (JP)

(73) Assignee: SEIKO EPSON CORPORATION, Tokyo (JP)

(21) Appl. No.: 13/175,441

(22) Filed: Jul. 1, 2011

(30) Foreign Application Priority Data
Jul. 12, 2010 (JP) 2010-157632

(51) Int. Cl. B41J 29/38

(52) U.S. Cl. 347/9

(57) ABSTRACT

A printing device includes a print head, a carriage moveable in a width direction of a medium, a carriage driver that drives the carriage to move back and forth in the width direction within a movement range, a detector that detects a position of the carriage, and a controller that monitors the position of the carriage. The controller is also configured to reverse a direction of movement of the carriage using the carriage driver when the carriage is determined to be immovable at a first position within the movement range, and, when the carriage, after the direction of movement of the carriage has been reversed, is determined to be immovable at a second position within the movement range, to further reverse the direction of movement of the carriage again using the carriage driver, and to output an error after stopping the carriage between the first position and the second position.

### CROSS-REFERENCE TO RELATED APPLICATIONS

This application claims priority to Japanese Patent Application No. 2010-157632 filed on Jul. 12, 2010. The entire disclosure of Japanese Patent Application No. 2010-157632 is hereby incorporated herein by reference.

### BACKGROUND

1. Technical Field

The present invention relates to a printing device.

2. Related Art

An inkjet printer is an example of a printing device in which a carried is provided with a mounted recording head wherein pressure is applied to ink by a piezoelectric vibrator or a heating element, and ink droplets are discharged from a nozzle opening, and in which printing is performed by discharging the ink droplets from the recording head while the carriage is moved in the width direction (main scanning direction) of print paper. A carriage-driving motor and an encoder are used for the drive control of the carriage on which the recording head is mounted. The position and state of the carriage are ascertained by counting the encoder outputs as well as by monitoring the phase relationship and periods of the two encoder outputs when the carriage motor is driven, and control actions that are necessary in accordance with the carriage position and state, such as discharging the ink droplets from the nozzle on the recording head, are performed. Such printing devices are described in, for example, Japanese Laid-Open Patent Application Publication Nos. 9-52374, 2004-9710, 2004-58616, and the like.

### SUMMARY

In such printing devices, there is concern that a paper jam will occur in which the carriage and the print paper (hereinafter abbreviated as “paper”) interfere with each other. Driving the carriage when a paper jam has occurred causes the carriage to interfere with the jammed paper, the encoder output to become disrupted, and the carriage to become impossible to drive as the paper jam advances. In cases in which the carriage is rendered immovable in this way, the carriage becomes an obstacle during removal of the jammed paper, and the paper becomes difficult to remove when the carriage is left in the position it occupied at the time the error occurred. In this case, there is concern that the paper will become damaged when forcibly removed, and there is also concern that secondary or tertiary obstructions caused by the damaged paper scattering within the apparatus will occur. It is therefore proposed that the movement of the carriage be reversed and the carriage be retracted to a safe position in cases in which the carriage is rendered immovable.

However, it is possible that the carriage will be rendered immovable by another paper jam during the reversal and retraction. In this case as well, there is, therefore, concern that stopping the carriage will cause the paper to be damaged and obstacles to occur when the paper is forcibly removed in a manner similar to the one described above.

In view of this, one object of the present invention is to prevent damage to the paper and to reduce obstructions when a paper jam occurs.

A printing device according to a first aspect of the present invention includes a print head, a carriage, a carriage driver, a detector and a controller. The carriage is moveable in a width direction of a medium, the print head being mounted on the carriage. The carriage driver is configured and arranged to drive the carriage to move back and forth in the width direction within a movement range. The detector is configured and arranged to detect a position of the carriage. The controller is configured to monitor the position of the carriage in accordance with an output from the detector, to reverse a direction of movement of the carriage using the carriage driver when the carriage is determined to be immovable at a first position within the movement range, and, when the carriage, after the direction of movement of the carriage has been reversed, is determined to be immovable at a second position within the movement range, to further reverse the direction of movement of the carriage again using the carriage driver, and to output an error after stopping the carriage between the first position and the second position.

Other characteristics of the present invention are made apparent by the description of the present specification and the attached drawings.

### BRIEF DESCRIPTION OF THE DRAWINGS

Referring now to the attached drawings which form a part of this original disclosure:

FIG. 1 is a schematic structural view of an inkjet printer in the present embodiment;

FIG. 2 is a view showing a state in which a paper jam has occurred during printing;

FIG. 3 is a view showing control of a carriage when the paper jam occurs in FIG. 2;

FIG. 4 is a view showing another state in which a paper jam has occurred during printing;

FIG. 5 is a view showing control of a carriage when the paper jam occurs in FIG. 4;

FIG. 6 is a view showing a state in which paper jams have occurred in the present embodiment;

FIG. 7 is a view showing yet another state in which paper jams have occurred in the present embodiment;

FIGS. 8A to 8D are waveform diagrams showing the configuration of a pair of encoder outputs provided to a carriage motor; and

FIG. 9 is a control flowchart for a controller in the present embodiment.

### DETAILED DESCRIPTION OF EXEMPLARY EMBODIMENTS

At least the following aspects are made apparent by the description of the present specification and the attached drawings.

A printing device according to the embodiment includes a print head, a carriage, a carriage driver, a detector and a controller. The carriage is moveable in a width direction of a medium, the print head being mounted on the carriage. The carriage driver is configured and arranged to drive the carriage to move back and forth in the width direction within a movement range. The detector is configured and arranged to detect a position of the carriage. The controller is configured to monitor the position of the carriage in accordance with an output from the detector, to reverse a direction of movement of the carriage using the carriage driver when the carriage is determined to be immovable at a first position within the movement range, and, when the carriage, after the direction of movement of the carriage has been reversed, is determined to be immovable at a second position within the movement range, to further reverse the direction of movement of the carriage again using the carriage driver, and to output an error after stopping the carriage between the first position and the second position.

According to such a printing device, damage to paper can be prevented and obstructions can be reduced when a paper jam occurs.

In this printing device, the controller may be configured to stop the carriage at an intermediate point between the first position and the second position.

According to such a printing device, the carriage can be caused to retract to the safest position.

In this printing device, the controller may be configured to move the carriage intermittently while the position of the carriage is monitored from the second position until the carriage is stopped.

According to such a printing device, malfunctions such as the uncontrollable movement of the carriage can be prevented.

In this printing device, the first position, the second position, and the position at which the carriage is stopped may be the same position.

According to such a printing device, it is possible to prevent the movement mechanism from being damaged by the continuing forcible driving of the carriage that is unable to move either back or forth.

In this printing device, the controller may be configured to output the error after stopping the carriage between the first position and the second position, the error being indicative of that a degree of error is more serious than that of a usual error.

According to such a printing device, the user can be alerted to take greater caution when removing the medium.

In the following embodiments, an inkjet printer will be described as an example of a printing device.

### Embodiments

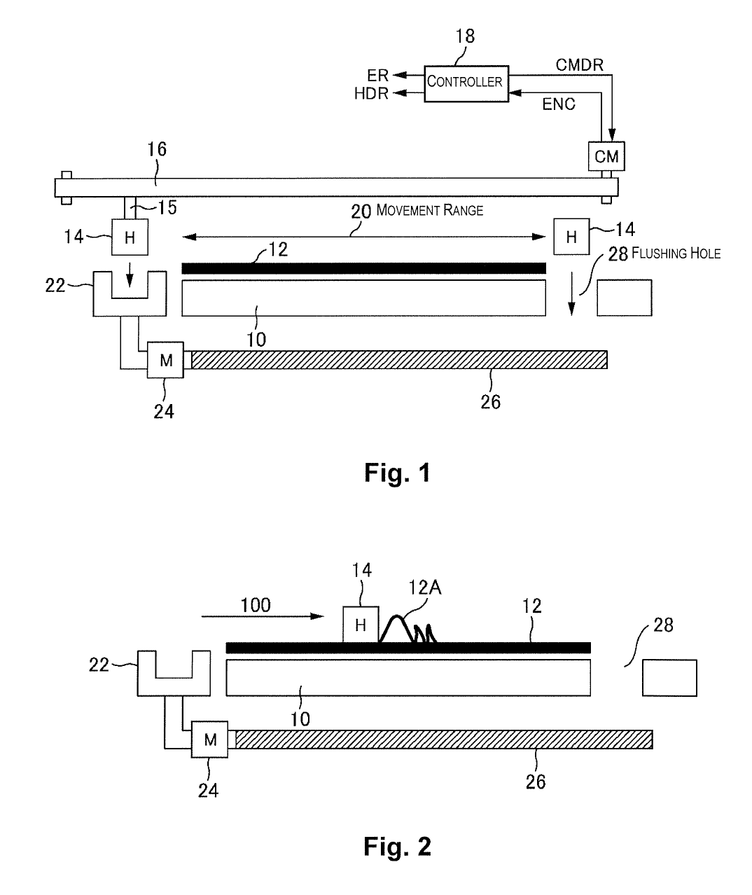

FIG. 1 is a schematic structural view of an inkjet printer in the present embodiment.

A paper feeder (not shown) is provided to a platen 10 on which a paper 12, which is a print medium, is disposed, and the paper 12 is moved in a sub-scanning direction. A carriage 14 on which a recording head H (which corresponds to a print head) is mounted is provided above the platen 10, and the carriage 14 moves back and forth in the width direction (main scanning direction) of the paper 12 within a movement range 20. The carriage 14 is linked via a linking tool 15 to a timing belt 16 driven by a carriage motor CM in order to allow the carriage to move back and forth.

An ink tank (not shown) is provided to the carriage 14 together with the recording head H, and ink is supplied via an ink supply tube (not shown) from an ink cartridge (not shown) mounted to the side of the ink tank facing the main body. Ink droplets are discharged from an ink nozzle by a piezo element or a heating element inside the recording head H.

A cap 22 is provided to the left end of the platen 10. The cap 22 caps the ink nozzle of the recording head H in a non-printing state to protect the ink inside the ink nozzle from drying. The ink droplets inside the ink nozzle are drawn by an ink-drawing motor 24 linked to the cap 22 to clean the ink nozzle when necessary. On the other side, a flushing hole 28 is provided to the right end of the platen 10, and the recording head H on the carriage 14 that has moved to the right end of the platen 10 discharges the ink droplets at a designated time interval or a designated amount of printing to prevent the ink inside the ink nozzle from hardening. An absorbent 26 is provided facing the flushing hole 28, and the ink droplets discharged from the flushing hole 28 are absorbed together with the ink drawn by the ink-drawing motor 24.

A controller 18 composed of a microprocessor or the like monitors the position of the carriage 14 by performing such actions as inputting encoder output ENC from drive-state detection means (not shown) having a pair of encoders (which correspond to a detector) attached to the carriage motor CM, and counting the encoder output. The controller 18 then outputs a drive command CMDR to the carriage motor CM to drive the carriage motor CM, and causes the carriage 14 to move back and forth within the movement range 20. The controller 18 outputs a head drive signal HDR for driving the piezo element or heating element in the recording head H based on the print data, outputs an error signal ER in a corresponding manner when a designated error occurs, and outputs the error to a display panel or an error lamp (not shown).

FIG. 2 is a view showing a state in which a paper jam has occurred during printing. This state is a case in which the carriage 14 is rendered immovable by a paper jam 12A or the like during movement in a rightward direction 100 from the left end provided with the cap 22. The moment the carriage 14 is determined to be immovable by the encoder output ENC, the driving of the carriage motor CM is stopped, the movement of the carriage 14 is stopped, and the carriage is left in that position, whereupon the carriage 14 becomes an obstacle to removing the jammed paper 12. There is also concern that the paper 12 will be damaged if forcibly removed.

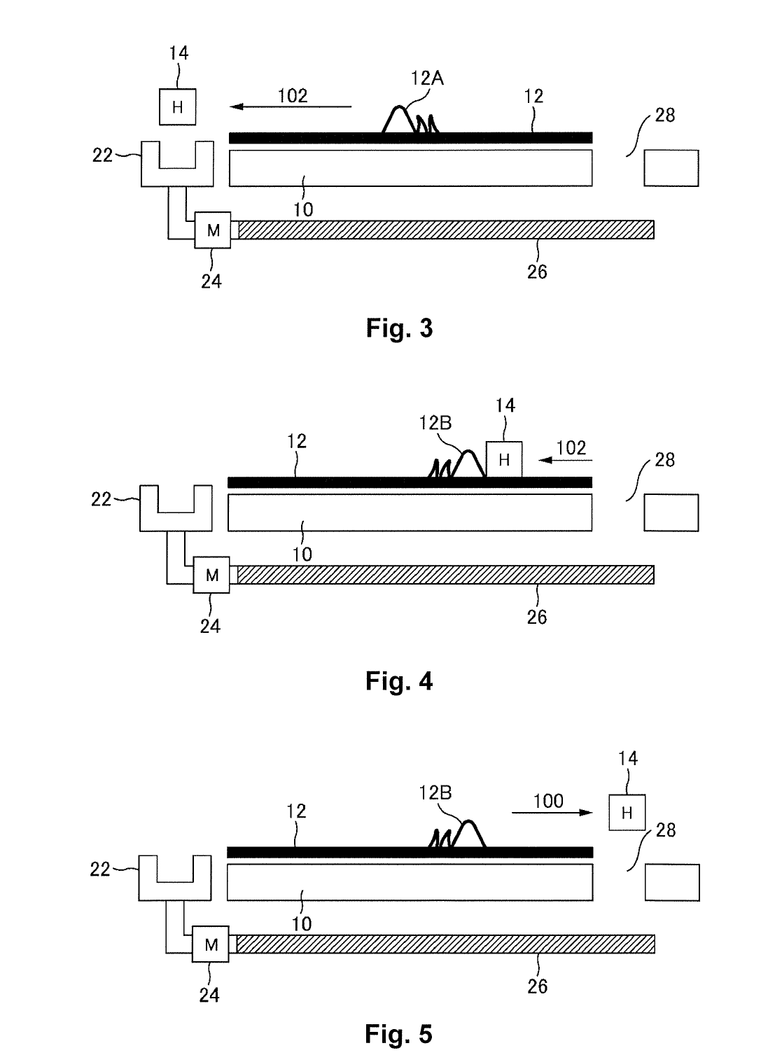

FIG. 3 is a view showing control of the carriage when the paper jam occurs in FIG. 2. In this example, the controller 18 causes the carriage 14 to move at a low speed in the leftward direction 102 opposite the immediately preceding direction of movement (rightward direction) by causing the drive of the carriage motor CM to rotate in reverse (reverse drive) when the carriage 14 is rendered immovable, and causes the carriage to retract to the left end part of the platen 10 provided with the cap 22, as shown in FIG. 3. The controller 18 outputs an error after the recording head H on the carriage 14 is capped by the cap 22. The result is that the carriage 14 does not become an obstacle because the carriage 14 is not within the printing range or the movement range 20 when the user removes the jammed paper 12 in accordance with the error output. The ink inside the nozzle can be prevented from drying because the nozzle of the recording head H of the carriage 14 is capped by the cap 22.

FIG. 4 is a view showing another state in which a paper jam has occurred during printing. This state is a case in which the carriage 14 is rendered immovable by a paper jam 12B or the like during movement in the leftward direction 102 from the right end provided with the flushing hole 28. In this case as well, the carriage 14 becomes an obstacle to removing the jammed paper 12 when the drive of the carriage motor CM is stopped at the detection of immovability, and the carriage 14 is left at the position of the paper jam 12B.

FIG. 5 is a view showing control of the carriage when the paper jam occurs in FIG. 4. In this example, the controller 18 causes the carriage 14 to move at a low speed in the rightward direction 100 opposite the immediately preceding direction of movement (leftward direction) by causing the drive of the carriage motor CM to rotate in reverse (reverse drive) when the paper is in the jammed state in FIG. 4, and causes the carriage to retract to the right end part of the platen provided with the flushing hole 28, as shown in FIG. 5. The controller 18 then outputs an error. In this case as well, the carriage 14 does not become an obstacle when the user removes the jammed paper 12 because the carriage 14 is retracted to outside of the movement range 20. In this case, however, the ink inside the ink nozzle cannot be prevented from drying because the recording head H of the carriage 14 is not capped by the cap 22.

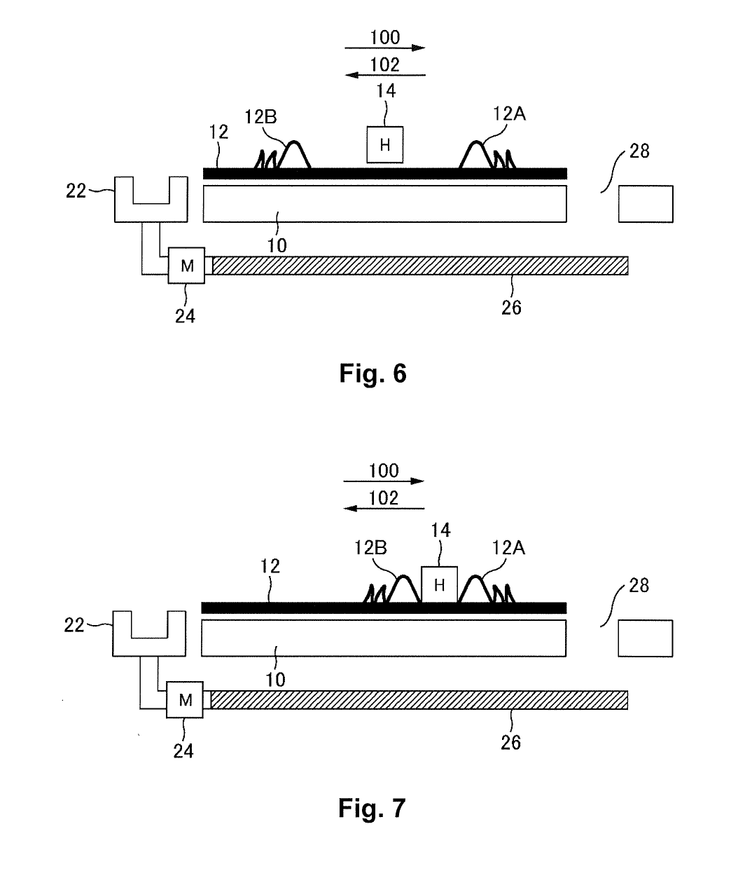

FIG. 6 is a view showing a state in which paper jams, that is, paper jams 12A and 12B, have occurred in the present embodiment.

Let us assume, for example, that the carriage 14 is rendered immovable by the paper jam 12A during movement from the left end of the drawing in the rightward direction 100. In this case, the carriage 14 may be caused to move (reverse movement) at a low speed in the leftward direction 102 opposite the immediately preceding direction of movement (rightward direction), as shown in FIG. 3. In FIG. 6, however, the carriage 14 cannot be caused to retract to outside of the movement range 20 and is rendered immovable by the paper jam 12B because of the presence of the paper jam 12B on the left side of the paper jam 12A. The carriage 14 becomes an obstacle to removing the jammed paper 12 when left in this position. There is concern that the paper will be damaged when the paper is forcibly removed in a state in which the carriage 14 is rendered immovable by the paper jam 12B, and there is also concern that the damaged paper, for example, will enter the sensors and cause a malfunction, or another secondary or tertiary obstruction will occur. There is also concern, for example, that a movement mechanism of the carriage 14 will be damaged when driving of the immovable carriage 14 is forcibly continued.

In FIG. 6, the carriage 14 is rendered immovable, first due to the paper jam 12B during movement in the leftward direction 102 in cases in which the movement occurs from the right side of the drawing in the leftward direction 102. In this case, the carriage 14 may be caused to move (reverse movement) at a low speed in the rightward direction 100 opposite the immediately preceding direction of movement (leftward direction), as shown in FIG. 5. In FIG. 6, however, the carriage 14 cannot be caused to retract to outside of the movement range 20 and is rendered immovable by the paper jam 12A because of the presence of the paper jam 12A on the right side of the paper jam 12B. In this case as well, the carriage 14 becomes an obstacle to removing the jammed paper 12 when left in this position. There is also concern that damage will occur in the same manner as above when the paper is forcibly removed and driving is forcibly continued.

In view of this, the controller 18 of the present embodiment causes the carriage 14 to move at a low speed in the direction opposite the immediately preceding direction of movement by causing the carriage motor CM to rotate in reverse (reverse drive) when movement is impossible due to the initial paper jam 12A (or 12B). After this, but before the carriage is caused to retract to outside the printing range, the direction of movement of the carriage 14 is reversed again by causing the carriage motor CM to rotate in reverse when the carriage 14 is rendered immovable by the paper jam 12B (or 12A). The controller then outputs an error after the carriage 14 is caused to stop between the paper jam 12A and the paper jam 12B. In the present embodiment, the stop position of the carriage 14 is established at an intermediate point between the position at which movement becomes impossible due to the paper jam 12A and the position at which movement becomes impossible due to the paper jam 12B. Establishing the stop position at an intermediate point in this manner allows the carriage 14 to be retracted to the safest position (position most unlikely to cause damage) when the paper 12 is removed.

There is concern that the paper jam has occurred due to the uncontrollable movement of the carriage 14, in which case there is also concern that the carriage 14 will move uncontrollably even after the direction of movement of the carriage 14 is reversed. Alternatively, there is concern that the carriage 14 will collide with the paper jam and become immovable, causing a malfunction to occur in the movement mechanism of the carriage 14. In view of this, the controller 18 in the present embodiment causes the carriage to move frame by frame in small increments to the intermediate position while confirming the position of the carriage 14 after the repeated reversal of the direction of movement of the carriage 14 (after the second reversal). The uncontrollable movement of the carriage 14 and other malfunctions can thereby be prevented. The error output after the carriage 14 is stopped at the intermediate point is preferably a serious error (hereinafter “error A”) for indicating that the degree of error is more serious than that of the usual fatal error (hereinafter “error B”). The user can be prompted to take notice by the output of the error A, and the operation for removing the paper 12 can be carefully performed. The occurrence of obstructions due to actions such as the forced removal of the paper 12 can thereby be reduced.

In this way, the carriage 14 in the present embodiment can be caused to retract to a safe position when the paper 12 is removed. Damage to the paper 12 can thereby by prevented, and obstructions can be reduced.

FIG. 7 is a view showing yet another state in which paper jams have occurred in the present embodiment. In this state, the carriage 14 is rendered immovable in both the leftward direction 102 and the rightward direction 100 by the paper jams 12A, 12B. Specifically, the position at which the carriage 14 is rendered immovable by the paper jam 12A, the position at which the carriage 14 is rendered immovable by the paper jam 12B, and the intermediate point are the same. In this case, the controller 18 stops the carriage motor CM at this position and outputs an error because the carriage 14 is rendered immovable in both directions between the paper jam 12A and the paper jam 12B. As a result, the carriage 14 is left in the position it occupied at the moment the error was detected. In this case, the carriage 14 is an obstacle to the user removing the jammed paper 12, but damage to the movement mechanism due to the continued forcible driving of the immovable carriage 14 can be prevented.

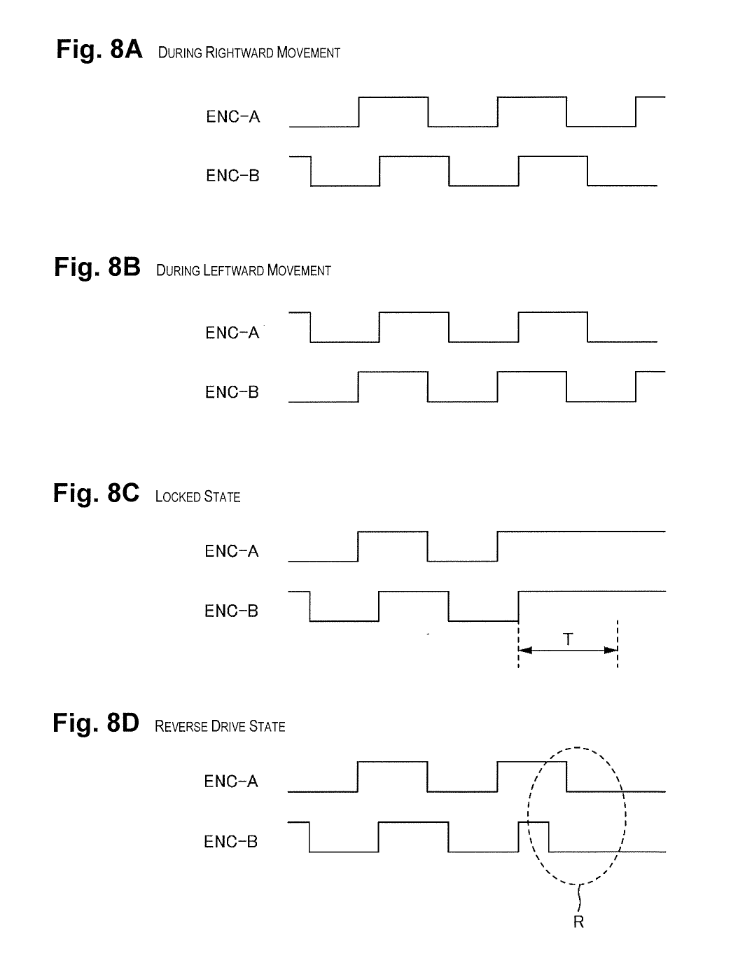

FIGS. 8A to 8D are waveform diagrams showing the configuration of a pair of encoder outputs provided to a carriage motor. FIG. 8A is an encoder output waveform diagram of a process in which the carriage motor CM rotates in one direction and the carriage 14 is caused to move in the rightward direction. This is a state in which the phase of the output ENC-A of an encoder A is advanced further than that of the output ENC-B of an encoder B, and the period of the encoder output is constant as long as the rotation speed of the carriage motor CM is constant. FIG. 8B is an encoder output waveform of a process in which the carriage motor CM rotates in the opposite direction and the carriage 14 is caused to move in the leftward direction. The state in this case is one in which the phase of the output ENC-B of the encoder B is advanced further than that of the output ENC-A of the encoder A. The controller 18 counts these encoder outputs in accordance with the phase state to continuously monitor the position of the carriage 14.

FIG. 8C is an encoder output waveform of a process in which the carriage is rendered immovable and is locked. When the pair of encoder outputs does not change any longer after a designated time T, it is detected that the carriage 14 is rendered immovable and is locked due to a paper jam or other such cause. FIG. 8D is an encoder output waveform of a process in which the carriage becomes incapable of moving and is temporarily moved in the opposite direction. Specifically, this is a case in which movement of the carriage 14 is stopped due to a paper jam or the like, and the carriage 14 is moved in the opposite direction by the pressure of the jammed paper 12. The reverse drive state R is detected as shown by the dashed circle.

In the present embodiment, the controller 18 considers the detected outputs of FIGS. 8A and 8B to be normal states, but considers the detected outputs of FIGS. 8C and 8D to be paper jam states, and rotates the carriage motor CM at a low speed in the opposite direction.

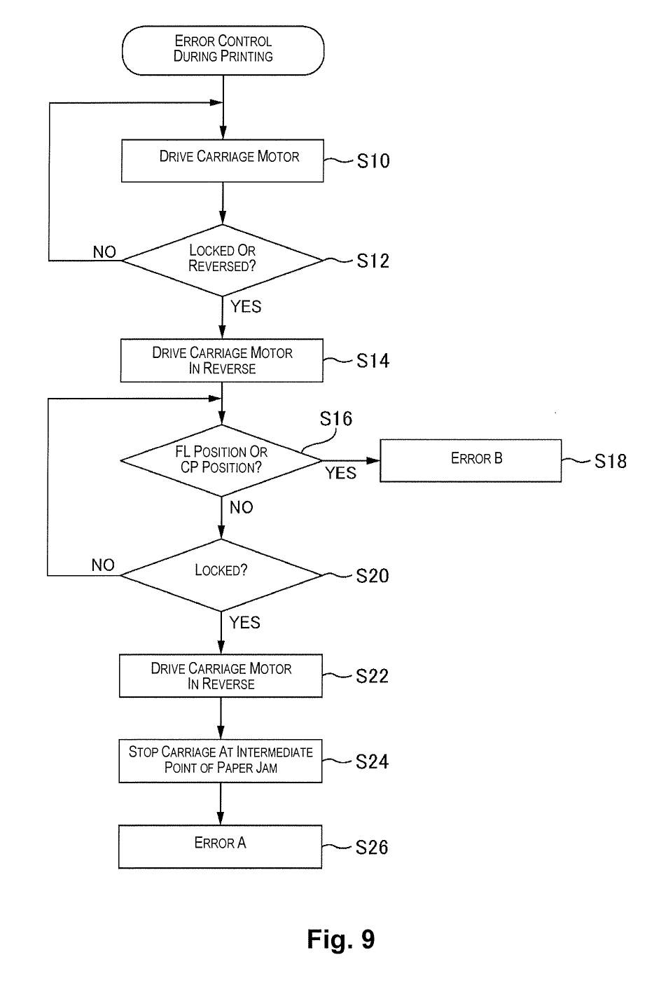

FIG. 9 is a control flowchart for a controller in the present embodiment.

The controller 18 first drives the carriage motor CM during printing, and the carriage 14 on which the recording head H is mounted is caused to move in either the rightward direction 100 or the leftward direction 102 (S10). When an encoder output waveform having a locked state or a reverse drive state such as that shown in FIGS. 8C and 8D is detected (S12: YES), the controller 18 drives the carriage motor CM in reverse at this position (which corresponds to the first position), and causes the carriage 14 to move (to rotate in reverse) at a low speed in the direction opposite the immediately preceding direction of movement (S14).

In this case, the controller 18 counts the encoder outputs, and monitors whether the carriage reaches the position of the cap 22 or the position of the flushing hole 28 (one of the positions at either end of the movement range 20) in cases in which reverse driving is possible, as shown in FIGS. 3 and 5. The error B (usual error) is output (S18) when it is detected that the carriage has moved to one of these positions (S16: YES). In cases in which the carriage 14 has moved to the position of the cap 22, the controller 18 further outputs the error B after the recording head H is capped by the cap 22. The ink can thereby be prevented from drying.

In contrast, when the carriage 14 does not reach one end of the movement range 20 (S16: NO), and a locked state is detected (S20: YES), the controller 18 again drives the carriage motor CM in reverse, and the carriage 14 is caused to move in the direction opposite the immediately preceding direction of movement (S22). Here, the controller 18 causes the carriage 14 to move frame by frame in small increments. Malfunctions such as the uncontrollable movement of the carriage 14 can thereby be prevented.

The carriage 14 is caused to stop (S24) at the intermediate point (specifically, the intermediate point of the paper jam) between the position at which the carriage is rendered immovable in step S12 and the position at which the carriage is rendered immovable in step S20, and the error A (serious error) is output. The user can thereby be prompted to take notice so as to remove the paper 12 with greater caution. For example, in cases in which the recording head H can be detached, the user removes the paper 12 after detaching the recording head H from the carriage 14 when the error A is output. In this way, the user is alerted to the presence of a serious state by the output of the error A, and the paper 12 can be removed with caution. Damage to the paper 12 can therefore be avoided and obstructions can be reduced.

According to the present invention, the controller 18 reverses the carriage 14 using the carriage motor CM, and moves the carriage 14 at a low speed in the opposite direction when the carriage is rendered immovable by a paper jam, as described above. The carriage 14 is again caused to reverse and to stop at the intermediate point between the position at which movement becomes impossible due to the initial jam and the position at which movement becomes impossible due to the next jam in cases in which the carriage 14 is rendered immovable after the drive reversal. The carriage 14 can be retracted to the safest position in the process of removing the jammed paper 12 in conjunction with the occurrence of the error, damage to the paper 12 can be avoided, and obstructions can be reduced.

### Other Embodiments

A printer and other components were described above as an embodiment, but the embodiment merely serves to facilitate understanding of the present invention and should not be interpreted as limiting the present invention. It is apparent that the present invention allows various changes and modifications to be made without departing from the scope thereof, and that these equivalents are included in the present invention.

For example, an inkjet printer is described as an example of a printing device in the aforementioned embodiment. However, the printing device is not limited to an inkjet printer, and may be a printing device such as one that discharges a fluid other than ink (a liquid form in which liquid and particulate functional materials are dispersed, or a fluid such as a gel). These methods and manufacturing methods also fall within the category of the range of application.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A printing device comprising:
a print head;
a carriage moveable in a width direction of a medium, the print head being mounted on the carriage;
a carriage driver configured and arranged to drive the carriage to move back and forth in the width direction within a movement range;
a detector configured and arranged to detect a position of the carriage; and
a controller configured to monitor the position of the carriage in accordance with an output from the detector, to reverse a direction of movement of the carriage using the carriage driver when the carriage is determined to be immovable at a first position within the movement range, and, when the carriage, after the direction of movement of the carriage has been reversed, is determined to be immovable at a second position within the movement range, to further reverse the direction of movement of the carriage again using the carriage driver, and to output an error after stopping the carriage between the first position and the second position.

2. The printing device according to claim 1, wherein
the controller is configured to stop the carriage at an intermediate point between the first position and the second position.

3. The printing device according to claim 1, wherein
the controller is configured to move the carriage intermittently while the position of the carriage is monitored from the second position until the carriage is stopped.

4. The printing device according to claim 1, wherein
the first position, the second position, and the position at which the carriage is stopped are the same position.

5. The printing device according to claim 1, wherein
the controller is configured to output the error after stopping the carriage between the first position and the second position, the error being indicative of that a degree of error is more serious than that of a usual error.
